(19) United States
(12) Patent Application Publication
(10) Pub. No.: US 2001/0007387 A1
(43) Pub. Date: Jul. 12, 2001

(54) Two-wheeled dolly for high-load balancing and efficient use on stairs

(76) Inventor: Francisco Gomez, Peoria, AZ (US)

Correspondence Address: MARTIN L. STONEMAN, 3113 N. 3rd Street, Phoenix, AZ, 85012-2601, US

(21) Appl. No.: 09/799,193

(22) Filed: Mar. 5, 2001

Related U.S. Application Data
(63) Continuation-in-part of application No. 09/436,594, filed on Nov. 9, 1999, now abandoned.

(51) Int. Cl. B62B 1/00; B62B 7/02

(52) U.S. Cl. 280/47.17; 280/47.315

(57) ABSTRACT

A two-wheeled dolly for better load balancing of high-profile loads and for use for more easily ramping up or down stairs so as to alleviate user strain and injury. The two-wheeled dolly comprises an L-shaped frame for supporting the load, an extendable handle which may be reversed to allow the user to more easily descend stairs with a load, and a pair of bicycle-type wheels each having a diameter in the range of about 16 inches to about 30 inches, a diameter of 23 inches being highly preferred for such stair use. The axle is more often under the load using the larger wheels, with better load balancing. Friction-type hand brakes may also be provided to more easily control and maneuver the two-wheeled dolly.

### CROSS-REFERENCE TO RELATED APPLICATION

This application is a continuation-in-part of related application Ser. No. 09/436,594, file Nov. 9, 1999, entitled “Hand Cart For Efficient Use On Stairs”.

### BACKGROUND

This invention relates to providing a two-wheeled dolly for improved balancing of high-profile loads and for more efficient use on stairs. More particularly, this invention concerns a two-wheeled dolly in which the dolly wheels are sized to produce a ramp effect on the steps, thereby allowing the user to more easily transport loads up and down stairs, with less effort and resultant back injuries, than conventional two-wheeled dollies. Also, such sizing of such wheels provides an axle location such that a relatively high-profile load, when the dolly is being moved in a typical angled position, will tend to have its center of gravity more over the axle, thus making the operation of the dolly easier and the load better balanced.

Typically, two-wheeled dollies are used to manually transport those loads which are often too heavy or cumbersome to carry by hand. A typical conventional two-wheeled dolly comprises an L-shaped frame structure for supporting the load and a set of wheels disposed on each side of the cart for allowing the load to be rolled across the ground surface while being supported by the frame. Often, two-wheeled dollies may be utilized to assist in transporting loads up or down a set of stairs. However, when using typical two-wheeled dollies for stair work, many of the benefits associated with the use of two-wheeled dollies are lost due to the fact that, when used to ascend the stairs, the user must lift the cart and load upward to the next successive stair landing. Also, descending stairs requires the operator to fully support, with his or her body, the load as the load is lowered to the next landing. For those individuals who must use two-wheeled dollies in conjunction with stairs on a regular basis, such as professional movers or the like, the repetitive lifting and lowering of heavy loads often leads to debilitating injuries and/or damage to the joints and muscles of the user, which may result in permanent injury.

Given the importance of alleviating injury which may arise from attempting the transport heavy loads up and down stairs using a conventional two-wheeled dolly of the type described above, a variety of two-wheeled dollies have been developed in an attempt to solve the aforementioned problems. For example, U.S. Pat. No. 4,142,732 issued to Boyd discloses a two-wheeled dolly in which each conventional small wheel is replaced by an arrangement in which three small wheels are rotatably attached via stub axles to a star plate which, in turn, is rotatably mounted to an axle. The theory motivating this type of arrangement being that as the cart ascends or descends the stairs, at least two of the three wheels on each side of the cart will always be in contact with the lands of successive steps, thereby allowing for smoother operation with less strain on the user. Although this two-wheeled dolly may be adequate for its intended use, the fact that each cart requires six individual wheels plus a pair of star plates for effective operation results in a more complex design, which may result in a two-wheeled dolly that is too costly for the infrequent users.

Other examples of various two-wheeled dolly designs for use in better navigating of stairs are described in U.S. Pat. Nos. 878,546 and 3,350,797 issued to, respectively, Lyon and Dassinger et al. Lyon teaches a two-wheeled dolly having a lever activated sub-frame, pivotally attached to the main cart frame, in which the bottom portion of the sub-frame overlies the stair landing of the next higher step. The operator then applies foot pressure to the lever thereby forcing the cart and load onto the successive stair landing. And Dassinger et al. teaches a two-wheeled dolly having skid-like bars which allow the cart and load to be pulled/inched to the successive stair landing. Again, although both two-wheeled dollies described above may be adequate for their respective intended uses, the Dassinger et al. cart still may require a significant expenditure of personal effort to inch the load up the steps, along with potential damage to the steps caused by the skid bars. And the Lyon two-wheeled dolly may pose a possible danger to the user since the user must balance on a single foot, while restraining the load, then attempt operate the lever with the other foot. Thus, none of the prior art referred to herein will accomplish the “stair” purpose of the present invention.

Furthermore, past two-wheeled dollies, because of the “axle” location (real or virtual), are hard to manage when transporting high-profile loads. The axle is too close to the base to permit, in this case, anything other than the user “carrying” most of such loads. These past problems are multiplied when using such a past dolly for stairs in that an essentially unbalanced load is being “bumped” up or down stairs.

### OBJECTS OF THE INVENTION

A primary object and feature of the present invention is to fulfill the above-mentioned needs by the provision of an improved two-wheeled dolly for more efficient use on stairs and for better load balancing. A further primary object and feature of the present invention is to provide such a two-wheeled dolly which is efficient, inexpensive, easy to use, and easy to manufacture. In addition, it is a primary object and feature of the present invention to provide such a two-wheeled dolly which minimizes the possibility of initial or cumulative injury to the user when used for stair climbing or stair descending, and also due to handling unbalanced loads. Other objects and features of this invention will become apparent with reference to the following invention descriptions.

### SUMMARY OF THE INVENTION

According to a preferred embodiment of the present invention, this invention provides a two-wheeled dolly comprising, in combination: a frame means, having a left side and a right side, for supporting the load; handle means, attached to such frame means, for allowing the user to hold and manipulate the two-wheeled dolly; and a two-wheel means, rotatably attached to such frame means, for producing a ramp effect along the steps; wherein such ramp effect is produced by simultaneous contact of such two-wheel means with at least two successive stair lands; and wherein such two-wheel means are rotatable about a single axle. It further provides such a dolly wherein such two-wheel means comprises: a first unitary wheel attached adjacent to such left side of such frame means; and a second unitary wheel attached adjacent to such right side of such frame means.

In addition, this invention provides such a dolly wherein such first unitary wheel and such second unitary wheel comprise spoked bicycle-type wheels of the type having a rim and tire; and, further, wherein such first wheel and such second wheel each has a diameter of about 16 inches to about 30 inches; and, further, wherein such first wheel and such second wheel each has a diameter of about 23 inches. Also it provides such a dolly further comprising a braking means for manually preventing rotation of such unitary wheels. And it provides such a dolly wherein such braking means comprises a brake assembly operatively connected to at least one of such first unitary wheel and such second unitary wheel, such brake assembly comprising: a brake lever attached to such handle means; a friction brake structured and arranged to releasably engage such rim; and a brake cable operatively connecting such brake lever to such friction brake. It also provides such a dolly wherein such handle means is extendably attached to such frame means; and, further, wherein such handle means is reversibly attached to such frame means; and, further, further comprising a blocking means, attached to such frame means, for preventing the load from contacting such two-wheel means. And it provides such a dolly wherein such blocking means comprises: a blocking structure attached to each of, and extending outwardly for a distance from, such left side and such right side of such frame means; wherein such distance extends to at least an outer surface of such first unitary wheel and an outer surface of such second unitary wheel; and wherein each such blocking structure is structured and arranged for placement between the load and a such unitary wheel.

Moreover, according to a preferred embodiment thereof, this invention provides a two-wheeled dolly comprising, in combination: a frame, having a left side and a right side, comprising: a plurality of interconnected elongated frame members, each such elongated member having an upper end and a lower end; and a substantially planar base portion attached to each of such lower ends of such elongated members; wherein such frame members and such base portion comprise together an L-shaped frame; a handle, attached to such frame, comprising: a plurality of elongated handle members each having an upwardly-convex curved upper end; a first unitary wheel attached to such left side of such frame; and a second unitary wheel attached to such right side of such frame; wherein such first unitary wheel and such second unitary wheel comprise spoked bicycle-type wheels of the type having a rim and tire; and wherein such first unitary wheel and such second unitary wheel have a diameter of about 16 inches to about 30 inches.

Even further, this invention provides such a dolly wherein such first unitary wheel and such second unitary wheel each have a diameter of about 23 inches; and, further, wherein such handle is reversibly attached to such frame; and, further, wherein such handle is longitudinally extendable relative to such frame; and, further, wherein the length of extension is about 24 inches. And it provides such a dolly wherein such elongated frame members comprise substantially hollow tubular members structured and arranged to receive such elongated handle members. It also provides such a dolly wherein: each such elongated frame member comprises at least one frame aperture provided along the longitudinal length of such elongated frame member; and each such elongated handle member comprises at least one handle aperture, concentrically alignable with such frame aperture, provided along the longitudinal length of such elongated handle members. And it provides such a dolly further comprising an engaging means for simultaneously engaging an aligned frame aperture and handle aperture; and, further, wherein such engaging means comprises a mechanical fastener.

Even in addition, this invention provides such a dolly further comprising a blocking structure attached to each of, and extending outwardly for a distance therefrom, such left side and such right side of such frame means, and wherein: such distance extends to at least an outer surface of such first unitary wheel and an outer surface of such second unitary wheel; and each such blocking structure is structured and arranged for placement between the load and such first unitary wheel and such second unitary wheel. And it provides such a dolly further comprising a brake assembly operatively connected to at least one of such first unitary wheel and such second unitary wheel, such brake assembly comprising: a brake lever attached to such handle means; a friction brake structured and arranged to releasably engage such rim; and a brake cable operatively connecting such brake lever to such friction brake. It also provides such a dolly wherein such first unitary wheel and such second unitary wheel each have a diameter of about 20 inches.

Additionally, according to a preferred embodiment thereof, this invention provides an L-shaped-profile two-wheeled dolly, having an axle, a load-carrying base and a vertical load-carrying frame, comprising sufficiently large diametered wheels and an axle location such that, when such dolly is being used at a dolly slant angle of about 45 degrees, such axle is located essentially directly beneath a height location along such frame, from such base, of more than about one and one-half feet. And it provides such a dolly wherein such height location is about two feet.

### BRIEF DESCRIPTION OF THE DRAWINGS

FIG. 1 is an elevation view of a preferred embodiment of the two-wheeled dolly of this invention being used to transport a load up a set of stairs.

FIG. 2 is an elevation view of a preferred embodiment of the two-wheeled dolly.

FIG. 3 is a rear view thereof.

FIG. 4 is a perspective view thereof illustrating a preferred frame construction.

FIG. 5 is a perspective view illustrating the reversible handle feature.

FIG. 6 is a partial front view thereof illustrating the blocking structure arrangement used to prevent load contact with the wheels.

FIG. 7 is a cross-sectional view, taken through section 7-7 of FIG. 6, illustrating the platform configuration.

FIG. 8 is a perspective view illustrating a preferred arrangement of the friction brakes.

FIG. 9 is a graph illustrating the relationships of the axle locations (and corresponding wheel sizes) to the height above the base plate for various slant angles of the two-wheeled dolly.

### DETAILED DESCRIPTION OF A PREFERRED EMBODIMENT AND THE BEST MODE OF PRACTICE

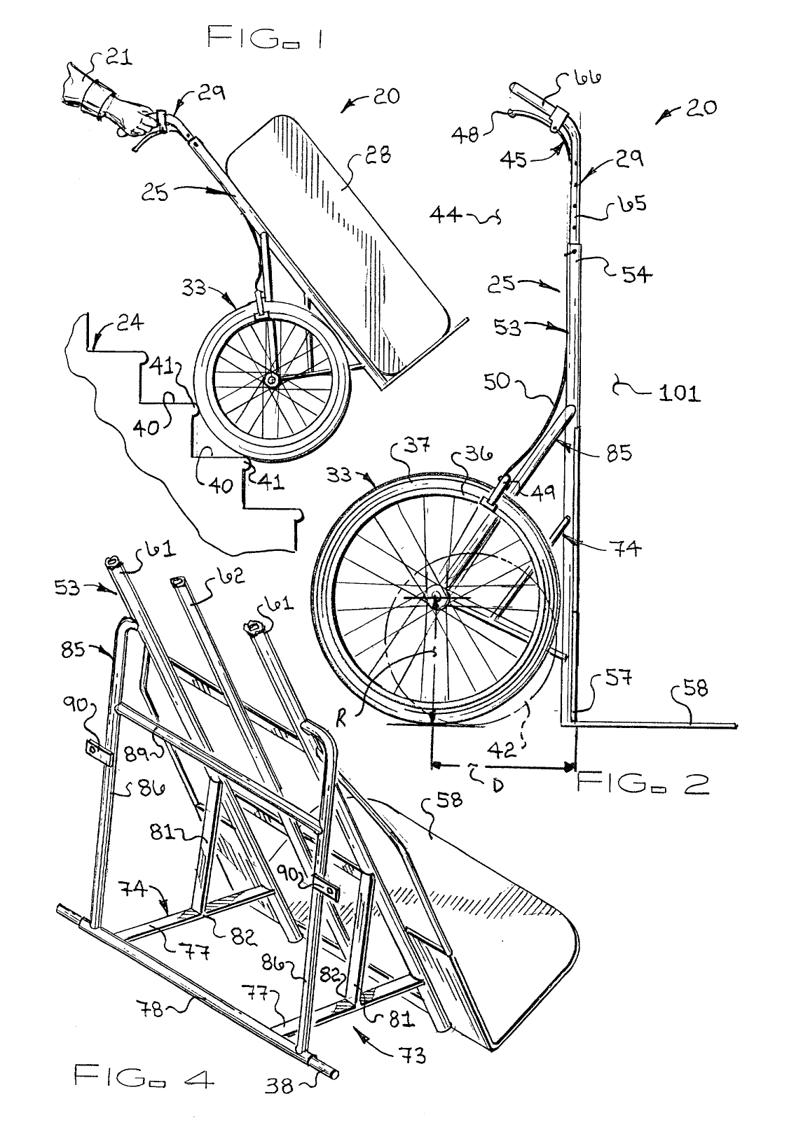

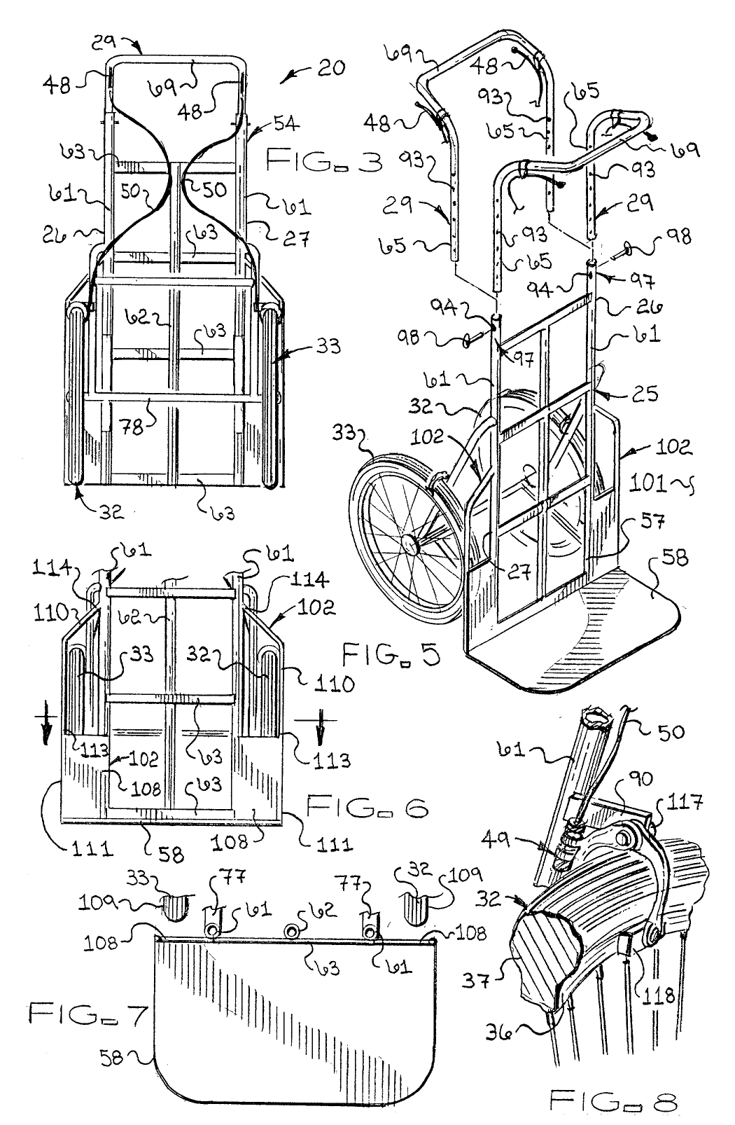

Referring now to the figures, shown in elevation in FIG. 1 is a preferred embodiment of the two-wheeled dolly 20 in use in its working environment. As will become apparent as this disclosure progresses, the two-wheeled dolly 20 of this invention is structured and arranged to efficiently allow the user 21 is ascend and descend stairs 24 without the corresponding jolt and strain typically associated with this activity. In addition, the two-wheeled dolly 20 is structured and arranged to be more efficient by changing the position of the axle, which changes the relative position of the center of gravity, of the load 28, on the two-wheeled dolly 20. Although the specific details of the two-wheeled dolly 20 will be described more thoroughly as this disclosure progresses, the two-wheeled dolly 20 of the present invention comprises a substantially L-shaped frame 25, having a left side 26 and right side 27 (as shown best in FIG. 3), for directly supporting the load 28 thereon. The frame 25 embodies herein a frame means, having a left side and a right side, for supporting the load.

Attached to the frame 25 is handle portion 29 which is provided so that the user 21 may hold and manipulate the two-wheeled dolly 20. The handle portion 29 embodies herein handle means, attached to such frame means, for allowing the user to hold and manipulate the two-wheeled dolly. As will be discussed more fully with respect to FIG. 5, the handle portion 29 is structured and arranged to be both easily extendable and reversible. As will be appreciated by those skilled in such art, by providing the handle portion 29 with extendable/reversible features, a more ergonomical two-wheeled dolly 20 is provided in that users of different heights are more easily accommodated, loads of larger dimensions may be more easily moved and, when the handle portion is reversed (see FIG. 5), the load is more easily transported down stairs.

Referring further to FIG. 1, and with reference to FIG. 2, rotatably attached to the frame 25 are a first wheel 32 (attached adjacent to such left side 26 of such frame means) and a second wheel 33 (attached adjacent to such right side 27 of such frame means) with only the second wheel 33 shown in FIGS. 1 and 2 for exemplary purposes. Each of the wheels 32 and 33 preferably comprises a spoked bicycle wheel, of the type having a rim 36 and tire 37, with each of the wheels 32 and 33 having a preferred diameter of preferably about 16-30 inches. Furthermore, each of the wheels 32 and 33 is rotatably coupled, in well-known ways, to a single axle 38 (axle 38 shown best in FIG. 4). This arrangement embodies herein an arrangement wherein such stair climbing means are rotatable about a single axle. Applicant has discovered that, for stairs within usual dimensions, providing the wheels 32 and 33 with a diameter of preferably about 16-30 inches, the wheels 32 and 33 always remain in contact with at least two successive stair lands 40, most preferably simultaneous contact with two successive stair land leading edges 41, as shown, thereby producing a ramp effect which allows the two-wheeled dolly 20 to more smoothly navigate the stairs 24, curbs (not shown), or other elevated obstacles without the attendant jolt and strain associated with typical two-wheeled dollies.

Applicant has further discovered by actual use that different wheel diameter sub-ranges within the above mentioned preferred range operate most efficiently for different terrain types that the two-wheeled dolly 20 might be utilized. For primarily stair work, each of the wheels 32 and 33 has a preferred diameter of about 20-30 inches; and about 23 inches is highly preferred for such work. For mixed terrain work such as a mixture of stairs, occasional curbs, and flat terrain (including grassy or muddy terrain), the preferred range is 16-20 inches; more preferably 18-20 inches, with about 19 inches being very highly preferred for such use. An example of the two-wheeled dolly 20 being provided with the smaller diameter wheels for mixed terrain work is as shown in FIG. 2 with the smaller wheel being shown in alternate detail as reference numeral 42. The wheels 32 and 33 embody herein stair climbing means, rotatably attached to such frame means, for producing a ramp effect along the steps.

To prevent the wheels 32 and 33 from contacting load 28, the wheels 32 and 33 are structured and arranged for placement substantially completely within the user side 44 of the frame 25, as shown best in FIG. 2. To control the rate of ascent or descent when traversing stairs, the two-wheeled dolly 20 of the present invention is provided with a brake assembly 45, preferably coupled to each of the wheels 32 and 33. Each brake assembly 45 comprising a brake handle 48 attached in well-known ways to the handle portion 29 and operatively connected to each brake 49 by use of a brake cable 50. Although the details of the brake 49 will be discussed more fully in connection with FIG. 8, each brake 49, briefly stated, preferably comprises well-known friction-type brakes of the type used in connection with bicycles. The brake assembly 45 embodies herein braking means for manually preventing rotation of such unitary wheels.

With reference to FIGS. 2-4, the frame 25 comprises a substantially elongated frame portion 53 having an upper frame portion 54 and a lower frame portion 57. A substantially planar base portion 58 is attached, preferably integrally, to the lower frame portion 57 at a substantially right angle from a plane defined by the elongated frame portion 53. As shown in the FIG. 3 rear view, the elongated frame portion 53 comprises two substantially elongated side frame members 61, preferably comprising substantially hollow members, and a substantially elongated center frame member 62, all preferably made of a rigid material such as steel or the like and all having a length found in typical two-wheeled dollies. As shown best in FIG. 3, the frame members 61 and 62 are aligned in a substantially parallel relationship and are interconnected by use of a plurality of transverse cross members 63, each also preferably constructed from a rigid material such as steel or the like, and which are attached, preferably integrally, to each of the frame members 61 and 62. Attached adjacent the upper frame portion 54 is handle portion 29, comprising a plurality of substantially elongated handle members 65 each having an upwardly-convex curved upper end 66, as shown. Connecting the handle members 65 together is a cross member 69 which is attached, preferably integrally, to each of the curved upper ends 66.

Since the two-wheeled dolly 20 of the present invention incorporates wheels 32 and 33 having a substantially larger diameter than provided on a conventional two-wheeled dolly, the axle 38 is placed a further distance from the elongated frame portion 53 than typical, as shown, according to the present invention. The axle position is substantially above the base portion 58 and substantially behind the elongated frame portion 53. The relative position of the center of gravity, of a load 28, on the two-wheeled dolly 20 is thereby a relationship between the radius R (see FIGS. 2 and 9) of the wheels 32 and 33 (height above the ground) and the distance D the axle 38 is from the base plate side of the lower frame portion 57 (preferred to be about two inches plus R). The specific height and weight distribution of the load 28 will also effect the balancing of the load on the two-wheeled dolly 20. Such two-wheeled dollies are typically transported at about a 45 degree angle of incline of the frame 25 and base portion 58. The 45 degree angle generally provides the two-wheeled dolly 20 user with a preferred weight distribution allowing the user to best utilize their leverage capabilities while limiting the amount of effort required to move the load. For example, for a professional mover moving heavy furniture throughout the day, the described embodiment of the present invention can assist in reducing the movers fatigue and enhance the movability of the two-wheeled dolly 20 while loaded.

Although few loads are exactly balanced over an axle, there is a preferred range, illustrated in FIG. 9, where the weight balancing of taller loads, such as bookcases and other furniture or appliances, is distributed. For example, if a 20 inch wheel is utilized for wheels 32 and 33, then the R value is about 10 inches. The preferred distance from the back of the lower frame portion 57 is the radius plus two inches. Therefore, the distance D is 12 inches with an R value of 10 inches. With the base plate perpendicular to the frame, and the frame tilted at a preferred 45 degree angle, a weight load will be distributed directly over the axle at R+D, which in this case is 22 inches from the bottom of the base plate. The various curves in FIG. 9 clearly illustrate that the height above the base directly over the axle in applicant's embodiments (at a typical dolly angle of 45 degrees) varies from about 14 inched to 32 inches, thus providing maximum support for such loads as have a center of gravity lying over that portion of the frame (i.e., 14 to 32 inches above the base plate. It is noted that past dollies typically have axle locations (for the same angle and loads) beneath a point less than 10 inches from the base; and their best use is for loads with such low profiles as would place a center of gravity of such load over the lowest few inches of the frame from the ground.

In order to support the corresponding increase in the bending moment which will be present adjacent the axle 38, the frame 25 further comprises a wheel support structure 73, preferably also made of a rigid material such as steel or the like, which is attached, preferably integrally, to the user side 44 of the frame 25. As shown best in FIG. 4, the wheel support structure 73 comprises a lower support structure 74 which, in turn, comprises a plurality of brace members 77 extending between, and preferably integrally attached to, the axle support sleeve 78 and side frame members 61. For additional support, each of the brace members 77 may be provided with a support member 81 extending from the approximate midway point 82 of each brace member 77 to each side frame member 61.

The wheel support structure 73 also comprises an upper support structure 85 comprising side support members 86 attached to, and extending from, the side frame members 61 to the axle support sleeve 78. A transverse support member 89 may be attached, preferably integrally, to each side support member 86 for added support. Also shown in FIG. 4 are brake mounts 90 attached, preferably integrally, to each side support member 86. As will be discussed more fully later with respect to FIG. 8, the brake mounts 90 are used to securely mount each brake 49 to the frame 25.

Shown in perspective in FIG. 5 are the details of the removable and adjustable feature of handle portion 29. As shown, the handle members 65 are sized for concentric placement within the side frame members 61. Provided along the length of the handle members 65 are a plurality of apertures 93 which are sized and arranged for concentric alignability with the apertures 94 provided adjacent the top portion 97 of each side frame member 61. Adjusting the effective length of the handle portion 29 consists of simply manually extending the handle portion 29, relative to the frame 25, until the desired length is achieved. It is preferred that the longitudinal length of each handle member 29 (including the number of, and distance between, the apertures 93) be sufficient to provide a maximum length of extension of about 24 inches. This arrangement embodies herein an arrangement wherein such handle means is extendably attached to such frame means; and, further, wherein such handle is longitudinally extendable relative to such frame. The user then inserts a fastener 98, preferably a snap fastener, bolt, or other well-known fastener type, simultaneously through apertures 93 and 94, thereby effectively preventing inadvertent retraction or extensions of the handle portion 29 from the user-adjusted length. The fastener 98 embodies herein an engaging means for simultaneously engaging an aligned frame aperture and handle aperture.

In a like manner, the handle portion 29 may easily be reversed so that the cross member 69 of handle portion 29 lies within the load side 101 of the frame 25, as shown in FIG. 5. Reversal of the handle portion 29 consists of simply removing each fastener 98, manually drawing the handle members 65 out of the side frame members 61 and then reinserting the handle members 65 into the side frame members 61 in such a manner as to result in the cross member 69 of handle portion 29 being situated within the load side 101 of the frame 25. This arrangement embodies herein an arrangement wherein such handle means is reversibly attached to such frame means. To facilitate the extension/reversal process, it is preferred that each brake cable 50 (as shown best in FIG. 3) has a sufficient length to permit both full extension or reversal of the handle portion 29 without the need to remove and re-attach each brake handle 48.

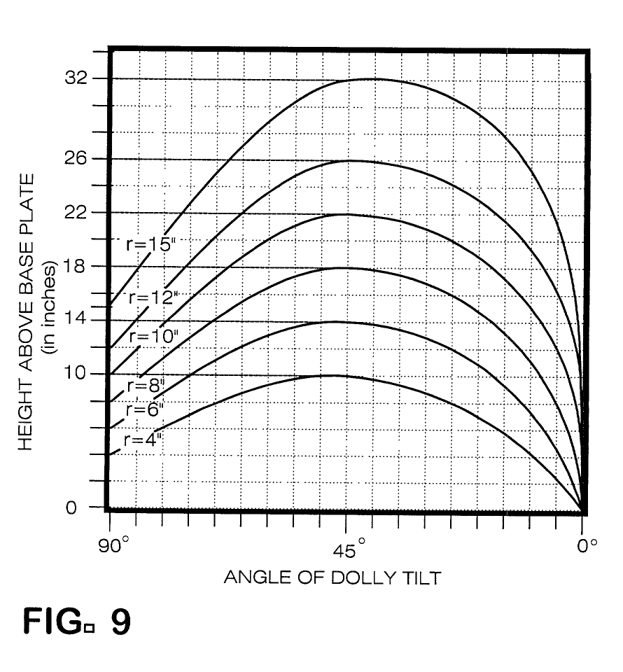

Referring further to FIG. 5 and introducing FIGS. 6 and 7, to prevent the load 28 from contacting the wheels 32 and 33, a means is provided to effectively allow uninhibited rotation of the wheels 32 and 33. Shown in FIGS. 5 and 6 is a preferred arrangement of blocking structures 102 (embodying herein a blocking means, attached to such frame means, for preventing the load from contacting such stair climbing means) which are attached, preferably integrally, to both the left side 26 and right side 27 of the frame 25 adjacent the lower frame portion 57. As shown, each blocking structure 102 comprises a substantially planar structure comprising a substantial planar plate section 108 having a width sufficient to extend beyond each outer surface 109 of each respective wheel 32 and 33 (as shown best in FIG. 7), and a bar member 110 having a first end 113 attached adjacent the distal ends 111 of each plate section 108, and a second end 114 attached to each respective side frame member 61.

To withstand the force associated with heavy loads, it is preferred that the plate section 108 have a thickness of about ⅛inch. It is also preferred that each bar member 110 be configured substantially as shown so as to also extend beyond each respective wheel 32 and 33, and have a sufficient length so as to create a point of attachment on each respective side frame member 61 above the largest wheel diameter chosen for the two-wheeled dolly 20. Furthermore, the bar member 110 is preferably selected from substantially cylindrical bar stock, preferably of a metallic material, having a sufficient diameter, preferably about ¼inch, to withstand forces associated with heavy loads. Also as shown in FIG. 7, the platform 58 preferably extends to the distal ends 111 of each plate section 108 thereby providing a platform 58 with a preferred length of about 20¼inches, and a preferred width of about 11½inches. By extending the platform 58 as described above, the two-wheeled dolly 20 is provided with an improved capability for supporting large and/or awkward loads. Often with the taller, heavier loads more suitable with the large-wheeled two-wheeled dolly of the present embodiment, it is more useful and preferred to have a larger base plate (than with smaller loads) because the footprint of the heavier load is generally larger. Shown in FIG. 8 is a preferred arrangement of the brake 49. For descriptive purposes, the following disclosure will make reference only to the arrangement associated with wheel 32, although it is to be understood that the arrangement associated with wheel 33 is substantially identical with the arrangement described herein. As shown, brake 49 is attached, in well-known ways, to the brake mount 90 by use of a brake hinge pin 117, of a well-known type, and is arranged, also in well-known ways, so that the brake pads 118 (one shown) lie adjacent the rim 36. As mentioned above, providing the two-wheeled dolly 20 with brakes 49 assists in controlling the load while ascending/descending stairs 24 or inclines. In addition, by providing both wheels 32 and 33 with a brake assembly 45, the user's 21 maneuverability on stair landings is greatly improved since the user 21 may apply the brake to one of wheels 32 or 33, thereby allowing the two-wheeled dolly 20 to sharply pivot about the braked wheel. The operation of each brake assembly 45 is accomplished in a manner well-known to those skilled in such art which, briefly, comprises the user applying pressure to brake handle 48 which, in turn, causes the brake pads 118 to pinch the rim 36, in a well-known fashion, thereby restricting rotation of the braked wheel 32 and/or 33.

It is especially noted that (see FIG. 9), according to a preferred embodiment, this invention provides an L-shaped-profile two-wheeled dolly, having an axle, a load-carrying base and a vertical load-carrying frame, comprising sufficiently large diametered wheels and an axle location such that, when such dolly is being used at a dolly slant angle of about 45 degrees, such axle is located essentially directly beneath a height location along such frame, from such base, of more than about one and one-half feet.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1. A two-wheeled dolly comprising, in combination:
(a) a frame means, having a left side and a right side, for supporting the load;
(b) handle means, attached to said frame means, for allowing the user to hold and manipulate the two-wheeled dolly; and
(c) a two-wheel means, rotatably attached to said frame means, for producing a ramp effect along the steps;
(d) wherein said ramp effect is produced by simultaneous contact of said two-wheel means with at least two successive stair lands; and
(e) wherein said two-wheel means are rotatable about a single axle.

2. The two-wheeled dolly of claim 1 wherein said two-wheel means comprises:
(a) a first unitary wheel attached adjacent to said left side of said frame means; and
(b) a second unitary wheel attached adjacent to said right side of said frame means.

3. The two-wheeled dolly of claim 2 wherein said first unitary wheel and said second unitary wheel comprise spoked bicycle-type wheels of the type having a rim and tire.

4. The two-wheeled dolly of claim 3 wherein said first wheel and said second wheel each has a diameter of about 16 inches to about 30 inches.

5. The two-wheeled dolly of claim 3 wherein said first wheel and said second wheel each has a diameter of about 23 inches.

6. The two-wheeled dolly of claim 3 further comprising a braking means for manually preventing rotation of said unitary wheels.

7. The two-wheeled dolly of claim 6 wherein said braking means comprises a brake assembly operatively connected to at least one of said first unitary wheel and said second unitary wheel, said brake assembly comprising:
(a) a brake lever attached to said handle means;
(b) a friction brake structured and arranged to releasably engage said rim; and
(c) a brake cable operatively connecting said brake lever to said friction brake.

8. The two-wheeled dolly of claim 1 wherein said handle means is extendably attached to said frame means.

9. The two-wheeled dolly of claim 1 wherein said handle means is reversibly attached to said frame means.

10. The two-wheeled dolly of claim 1 further comprising a blocking means, attached to said frame means, for preventing the load from contacting said two-wheel means.

11. The two-wheeled dolly of claim 10 wherein said blocking means comprises:
(a) a blocking structure attached to each of, and extending outwardly for a distance from, said left side and said right side of said frame means;
(b) wherein said distance extends to at least an outer surface of said first unitary wheel and an outer surface of said second unitary wheel; and
(c) wherein each said blocking structure is structured and arranged for placement between the load and a said unitary wheel.

12. A two-wheeled dolly comprising, in combination:
(a) a frame, having a left side and a right side, comprising:
(i) a plurality of interconnected elongated frame members, each said elongated member having an upper end and a lower end; and
(ii) a substantially planar base portion attached to each of said lower ends of said elongated members;
(iii) wherein said frame members and said base portion comprise together an L-shaped frame;
(b) a handle, attached to said frame, comprising:
(i) a plurality of elongated handle members each having an upwardly-convex curved upper end;
(c) a first unitary wheel attached to said left side of said frame; and
(d) a second unitary wheel attached to said right side of said frame;
(e) wherein said first unitary wheel and said second unitary wheel comprise spoked bicycle-type wheels of the type having a rim and tire; and
(f) wherein said first unitary wheel and said second unitary wheel have a diameter of about 16 inches to about 30 inches.

13. The two-wheeled dolly of claim 12 wherein said first unitary wheel and said second unitary wheel each have a diameter of about 23 inches.

14. The two-wheeled dolly of claim 12 wherein said handle is reversibly attached to said frame.

15. The two-wheeled dolly of claim 12 wherein said handle is longitudinally extendable relative to said frame.

16. The two-wheeled dolly of claim 15 wherein the length of extension is about 24 inches.

17. The two-wheeled dolly of claim 15 wherein said elongated frame members comprise substantially hollow tubular members structured and arranged to receive said elongated handle members.

18. The two-wheeled dolly of claim 17 wherein:
(a) each said elongated frame member comprises at least one frame aperture provided along the longitudinal length of said elongated frame member; and
(b) each said elongated handle member comprises at least one handle aperture, concentrically alignable with said frame aperture, provided along the longitudinal length of said elongated handle members.

19. The two-wheeled dolly of claim 18 further comprising an engaging means for simultaneously engaging an aligned frame aperture and handle aperture.

20. The two-wheeled dolly of claim 19 wherein said engaging means comprises a mechanical fastener.

21. The two-wheeled dolly of claim 12 further comprising a blocking structure attached to each of, and extending outwardly for a distance therefrom, said left side and said right side of said frame means, and wherein:
(a) said distance extends to at least an outer surface of said first unitary wheel and an outer surface of said second unitary wheel; and
(b) each said blocking structure is structured and arranged for placement between the load and said first unitary wheel and said second unitary wheel.

22. The two-wheeled dolly of claim 12 further comprising a brake assembly operatively connected to at least one of said first unitary wheel and said second unitary wheel, said brake assembly comprising:
(a) a brake lever attached to said handle means;
(b) a friction brake structured and arranged to releasably engage said rim; and
(c) a brake cable operatively connecting said brake lever to said friction brake.

23. The two-wheeled dolly of claim 12 wherein said first unitary wheel and said second unitary wheel each have a diameter of about 20 inches.

24. An L-shaped-profile two-wheeled dolly, having an axle, a load-carrying base and a vertical load-carrying frame, comprising sufficiently large diametered wheels and an axle location such that, when said dolly is being used at a dolly slant angle of about 45 degrees, said axle is located essentially directly beneath a height location along said frame, from said base, of more than about one and one-half feet.

25. The two-wheeled dolly of claim 24 wherein said height location is about two feet.

26. The two-wheeled dolly of claim 24 wherein said load-carrying base extends forwardly from said vertical load-carrying frame a distance of more than about ten inches.
